(19) United States
(12) Patent Application Publication
(10) Pub. No.: US 2024/0113352 A1
(43) Pub. Date: Apr. 4, 2024

(54) SYSTEMS AND METHODS FOR HEATING BATTERY IN LOW-TEMPERATURE ENVIRONMENTS

(71) Applicant: Dell Products L.P., Round Rock, TX (US)

(72) Inventors: Tsz LEUNG, New Taipei City (TW); Chia Fa CHANG, New Taipei City (TW); Jui Chin FANG, Taipei City (TW); John R. LERMA, Cedar Park, TX (US); Wen-Yung CHANG, Taoyuan City (TW)

(73) Assignee: Dell Products L.P., Round Rock, TX (US)

(21) Appl. No.: 17/956,535

(22) Filed: Sep. 29, 2022

(51) Int. Cl. H01M 10/615; H01M 10/0525; H01M 10/48; H01M 10/63; H01M 10/657

(52) U.S. Cl. CPC H01M 10/615; H01M 10/0525; H01M 10/486; H01M 10/63; H01M 10/657; H01M 2220/10

(57) ABSTRACT

An information handling system may include one or more information handling resources, a main battery configured to power the one or more information handling resources, a heater thermally coupled to the main battery, a supportive battery configured to power the heater, and a control unit communicatively coupled to the supportive battery and configured to control the supportive battery and the heater to heat the main battery.

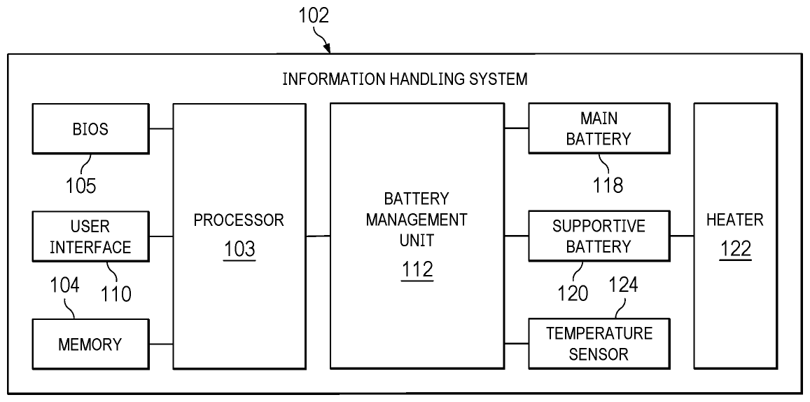

### TECHNICAL FIELD

The present disclosure relates in general to information handling systems, and more specifically to systems and methods for heating a battery of an information handling system in low-temperature environments.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many modern information handling systems utilize one or more rechargeable batteries for powering electrical and electronic components of the information handling system. Such batteries may be used when an external power supply is not available to the information handling system, whether such external power supply is unavailable due to a power grid failure or because a user decouples the information handling system from the external power supply for mobile usage of the information handling system.

A common type of battery used in information handling systems is a lithium-ion battery. One disadvantage of lithium-ion batteries is that the energy efficiency of a lithium-ion battery may be a function of temperature, and as a consequence, lithium-ion batteries may have a lower energy efficiency at low temperatures due to a high internal impedance at low temperatures. Accordingly, a lithium-ion battery may have very limited capacity at low temperatures.

### SUMMARY

In accordance with the teachings of the present disclosure, the disadvantages and problems associated with battery efficiency at low temperatures may be reduced or eliminated.

In accordance with embodiments of the present disclosure, an information handling system may include one or more information handling resources, a main battery configured to power the one or more information handling resources, a heater thermally coupled to the main battery, a supportive battery configured to power the heater, and a control unit communicatively coupled to the supportive battery and configured to control the supportive battery and the heater to heat the main battery.

In accordance with these and other embodiments of the present disclosure, a method may include electrically coupling one or more information handling resources to a main battery such that the main battery is configured to power the one or more information handling resources, thermally coupling a heater to the main battery, electrically coupling a supportive battery to the heater such that the supportive battery is configured to power the heater, and controlling, with a control unit, the supportive battery and the heater in order to heat the main battery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawing, in which like reference numbers indicate like features, and wherein:

THE FIGURE illustrates a block diagram of an example information handling system, in accordance with certain embodiments of the present disclosure.

### DETAILED DESCRIPTION

Preferred embodiments and their advantages are best understood by reference to THE FIGURE, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSes), buses, memories, I/O devices and/or interfaces, storage resources, network interfaces, motherboards, and/or any other components and/or elements of an information handling system.

THE FIGURE illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). In yet other embodiments, information handling system 102 may be a mobile device (e.g., a handheld gaming device, a smartphone, a tablet, etc.). As depicted in THE FIGURE, information handling system 102 may include a processor 103, a memory 104 communicatively coupled to processor 103, a basic input/output system (BIOS) 105 communicatively coupled to processor 103, a user interface 110 communicatively coupled to processor 103, a battery management unit 112 communicatively coupled to processor 103, a main battery 118 electrically coupled to selected components of information handling system 102, a supportive battery 120, a heater 122 electrically coupled to supportive battery 120 and thermally coupled to main battery 118, and temperature sensor 124 communicatively coupled to battery management unit 112.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

User interface 110 may comprise any instrumentality or aggregation of instrumentalities by which a user may interact with information handling system 102. For example, user interface 110 may permit a user to input data and/or instructions into information handling system 102 (e.g., via a keyboard, pointing device, push button, and/or other suitable component), and/or otherwise manipulate information handling system 102 and its associated components. User interface 110 may also permit information handling system 102 to communicate data to a user, e.g., by way of a display device or visual indicators such as light-emitting diodes.

Battery management unit 112 may comprise a microprocessor, digital signal processor, application-specific integrated circuit, field-programmable gate array, electrically erasable programmable read only memory, or any combination thereof, or any other device, system, or apparatus for controlling operation of a battery subsystem comprising main battery 118 and supportive battery 120, as described in greater detail below. As such, battery management unit 112 may comprise firmware, logic, and/or data for controlling functionality of the battery subsystem.

Main battery 118 may comprise a power source having one or more electrochemical cells with external connections for powering one or more electrical devices of information handling system 102, including processor 103, memory 104, BIOS 105, and battery management unit 112. In particular, main battery 118 may store chemical energy which may be converted to electrical energy to power one or more electrical devices. In some embodiments, main battery 118 may comprise a rechargeable battery, for which electrical energy delivered to main battery 118 may be converted to chemical energy, for storage and later conversion into electrical energy. In some embodiments, main battery 118 may comprise a lithium-ion battery.

Supportive battery 120 may comprise a power source having one or more electrochemical cells with external connections for powering heater 122. In particular, supportive battery 120 may store chemical energy which may be converted to electrical energy to power heater 122. In some embodiments, supportive battery 120 may comprise a rechargeable battery, for which electrical energy delivered to battery 118 may be converted to chemical energy, for storage and later conversion into electrical energy. In these and other embodiments, supportive battery 120 may be dedicated to powering heater 122 but no other components of information handling system 102. In some embodiments, supportive battery 120 may comprise a lithium titanate oxide battery.

Heater 122 may include any device, system or apparatus configured to generate thermal energy and apply such generated thermal energy to main battery 118. In some embodiments, heater 122 may be mechanically coupled to main battery 118 via an adhesive, thermal interface material, and/or mechanical compression. As described above, operation of heater 122 may be controlled based on operation of supportive battery 120, which may in turn be controlled by battery management unit 112. Thus, battery management unit 112 may ultimately control components of heater 122 in order to produce a desired temperature of or proximate to main battery 118.

Temperature sensor 124 may comprise any system, device, or apparatus (e.g., a thermometer, thermistor, etc.) configured to communicate a signal to battery management unit 112 indicative of a temperature within information handling system 102, in particular a temperature of or proximate to main battery 118.

In addition to processor 103, memory 104, BIOS 105, user interface 110, battery management unit 112, main battery 118, supportive battery 120, heater 122, and temperature sensor 124, information handling system 102 may include one or more other information handling resources.

In operation, main battery 118 may be used, in the absence of an external power supply, for powering almost all components of information handling system 102 while supportive battery 120 may be used to power heater 122. Thus, in low-temperature environments in which the energy efficiency of main battery 118 may be decreased, battery management unit 112 may enable supportive battery 120 to deliver electric energy to heater 122, such that heater 122 generates heat to increase a temperature of or proximate to main battery 118 in order to increase the energy efficiency of main battery 118. In some embodiments, heater 122, under the control of battery management unit 112 by virtue of control by battery management unit 112 of electrical energy delivered from supportive battery 120 to heater 122, may operate with temperature sensor 124 in a closed feedback loop, in order to regulate the temperature measured by temperature sensor 124 at a particular desired temperature or temperature range.

Further, battery management unit 118 heating of main battery 118 with supportive battery 120 and heater 122 may operate in a plurality of heating modes. For example, in some embodiments, in a manual mode, control of supportive battery 120 and heater 122 may be in immediate response to a user's interaction with components of user interface 110 (e.g., toggling on or off based on user's interaction with a button, setting of a desired temperature for heating based on user's interaction with a button, etc.).

As another example, in some embodiments, in an automatic mode, control of supportive battery 120 and heater 122 may be responsive to an operating system status (e.g., sleep/hibernate, direct current (DC) on, AC power connected, DC off) of information handling system 102. In such an automatic mode, while in a sleep/hibernate status of the operating system, battery management unit 112 may control supportive battery 120 and heater 122 to maintain main battery 118 at a temperature (e.g., a minimum temperature) that allows the operating system to exit sleep/hibernate mode and effectively power components of information handling system 102. Further, in such an automatic mode, while in a DC on status of the operating system, battery management unit 112 may control supportive battery 120 and heater 122 to maintain main battery 118 at a temperature at which it has the most energy efficiency. Also, in such an automatic mode, while in an AC power connected status of the operating system, battery management unit 112 may control supportive battery 120 and heater 122 to maintain main battery 118 at a temperature at which battery life of main battery 118 may be maximally prolonged. In addition, in such automatic mode, if the operating system status changes to a DC off or shipping and storage mode, battery management unit 112 may control supportive battery 120 and heater 122 to turn off until such time a user interacts with user interface 110 to indicate that heater 122 should again be enabled to heat up main battery 118.

In some embodiments, multiple automatic modes may be available. For example, such embodiments may include a power user mode to maximize performance of information handling system 102 at lower temperatures and an energy save mode to heat main battery 118 to higher temperatures to maximize energy efficiency of main battery 118.

In these and other embodiments, battery management unit 112 may cause user interface 110 to communicate to a user mode and/or status information associated with heating of main battery 118 with heater 122, for example via one or more light-emitting diodes.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
one or more information handling resources;
a main battery configured to power the one or more information handling resources;
a heater thermally coupled to the main battery;
a supportive battery configured to power the heater; and
a control unit communicatively coupled to the supportive battery and configured to control the supportive battery and the heater to heat the main battery.

2. The information handling system of claim 1, further comprising a temperature sensor configured to sense a temperature associated with the main battery.

3. The information handling system of claim 2, wherein the supportive battery, the heater, the control unit, and the temperature sensor act as a feedback control loop to regulate the temperature at a desired temperature level.

4. The information handling system of claim 1, wherein the main battery comprises a lithium-ion battery.

5. The information handling system of claim 1, wherein the supportive battery comprises a lithium titanate oxide battery.

6. The information handling system of claim 1, wherein the control unit controls the supportive battery and the heater in response to manual user input.

7. The information handling system of claim 1, wherein the control unit controls the supportive battery and the heater in response to an operating system status of the information handling system.

8. A method comprising:
electrically coupling one or more information handling resources to a main battery such that the main battery is configured to power the one or more information handling resources;
thermally coupling a heater to the main battery;
electrically coupling a supportive battery to the heater such that the supportive battery is configured to power the heater; and
controlling, with a control unit, the supportive battery and the heater in order to heat the main battery.

9. The method of claim 8, further comprising sensing a temperature associated with the main battery with a temperature sensor.

10. The method of claim 9, further comprising regulating the temperature at a desired temperature level with a feedback control loop comprising the supportive battery, the heater, the control unit, and the temperature sensor.

11. The method of claim 8, wherein the main battery comprises a lithium-ion battery.

12. The method of claim 8, wherein the supportive battery comprises a lithium titanate oxide battery.

13. The method of claim 8, further comprising controlling the supportive battery and the heater in response to manual user input.

14. The method of claim 8, further comprising controlling the supportive battery and the heater in response to an operating system status of the information handling system.
